(19) United States
(12) Patent Application Publication
(10) Pub. No.: US 2026/0161787 A1
(43) Pub. Date: Jun. 11, 2026

(54) STORAGE DEVICE, STORAGE SYSTEM, AND METHOD OF OPERATING STORAGE SYSTEM

(71) Applicant: SAMSUNG ELECTRONICS CO., LTD., Suwon-si (KR)

(72) Inventors: Wonchul LEE, Suwon-si (KR); Jisoo KIM, Suwon-si (KR); Sungkyu PARK, Suwon-si (KR); Jin-Hwan PARK, Suwon-si (KR)

(73) Assignee: SAMSUNG ELECTRONICS CO., LTD., Suwon-si (KR)

(21) Appl. No.: 19/398,548

(22) Filed: Nov. 24, 2025

(30) Foreign Application Priority Data
Dec. 11, 2024 (KR) 10-2024-0183993

(51) Int. Cl. G06F 21/56

(52) U.S. Cl. CPC G06F 21/566; G06F 2221/034

(57) ABSTRACT

A storage system includes a plurality of storage devices, each configured to store a trap file and a system controller configured to control the plurality of storage devices based on a plurality of commands received from a host. The system controller may be configured to reduce an operating speed of at least one storage device among the plurality of storage devices based on an outlier notification being received from the at least one storage device, and perform a malware detection operation based on commands corresponding to the outlier notification, among the plurality of commands. The at least one storage device may be configured to transmit the outlier notification to the system controller based on an access to a trap area, in which the trap file is stored, being detected.

### CROSS-REFERENCE TO RELATED APPLICATION(S)

This U.S. non-provisional application claims priority under 35 USC § 119 to Korean Patent Application No. 10-2024-0183993, filed on December 11, 2024, in the Korean Intellectual Property Office, the disclosure of which is herein incorporated by reference in its entirety.

### BACKGROUND

The present disclosure relates to a storage device, a storage system, and a method of operating the storage system.

Ransomware is a type of malware that inflicts significant harm on users by secretly encrypting critical data, files, or folders and withholding decryption keys until a ransom is paid. Ransomware attacks target various fields, including healthcare, finance, energy, and media, and various solutions are being developed to prepare for the ransomware attack.

For example, input/output (I/O) commands may be analyzed in real time to detect a ransomware attack on a storage system. However, this causes performance degradation of the storage system. An additional hardware accelerator is required to address such an issue.

### SUMMARY

One or more embodiments provide a storage device, a storage system, and a method of operating the storage system, all of which are more efficiently protected from malware without performance degradation.

According to one or more embodiment, a storage system includes a plurality of storage devices, each configured to store a trap file and a system controller configured to control the plurality of storage devices based on a plurality of commands received from a host. The system controller may be configured to reduce an operating speed of at least one storage device among the plurality of storage devices based on an outlier notification being received from the at least one storage device, and perform a malware detection operation based on commands corresponding to the outlier notification, among the plurality of commands. The at least one storage device may be configured to transmit the outlier notification to the system controller based on an access to a trap area, in which the trap file is stored, being detected.

Each of the plurality of storage devices may be configured to set a logical block address (LBA) range corresponding to the trap area as a write protection area, and transmit the outlier notification to the system controller when an access to the write protection area is detected.

Each of the plurality of storage devices may be configured to transmit the outlier notification to the system controller via an asynchronous event.

Each of the plurality of storage devices may operate in one of a plurality of power states having different operating speeds, and the system controller may be configured to modify a power state of the at least one storage device to reduce an operating speed of the at least one storage device.

The system controller may be configured to reduce operating speeds of the plurality of storage devices based on the outlier notification being received from the at least one storage device.

The plurality of storage devices may include a first group used by a first host and a second group used by a second host, the first group may include the at least one storage device and additional storage devices, and the system controller may be configured to reduce operating speeds of storage devices included in the first group based on the outlier notification being received from the at least one storage device.

The system controller may be configured to store information on the plurality of commands based on a sliding window having a predetermined size, and perform the malware detection operation based on information on commands included in the sliding window when the outlier notification is received.

The information on the commands may include information on a type of each command and information and logical block address (LBA) information corresponding to each command.

The system controller may be configured to extract a plurality of features from the information on command included in the sliding window when the outlier notification is received, and apply the extracted features to a malware detection algorithm based on machine learning to perform the malware detection operation. The malware detection algorithm may include at least one of a convolutional neural network, a recurrent neural network, a principal component analysis model, or a random forest model.

The malware detection algorithm may be configured to output a score for each of a plurality of pieces of predefined malware based on the extracted features.

The system controller may be configured to provide information related to the outlier notification to the host.

The information related to the outlier notification may include at least one of (i) information on a group including the at least one storage device transmitting the outlier notification, (ii) information on storage devices included in the group, (iii) information on command included in the sliding window at a time point at which the outlier notification is received, (iv) command input/output history information of the at least one storage device transmitting the outlier notification, or (v) telemetry data of the at least one storage device transmitting the outlier notification.

According to one or more embodiments, a storage device includes a memory device comprising a trap area in which a trap file transferred from a host is stored and a memory controller configured to set a logical block address (LBA) range corresponding to the trap area as a write protection area, and generate an outlier notification when an access to the write protection area is detected.

The memory controller may be configured to transmit the outlier notification to a system controller external to the storage device via an asynchronous event.

The memory controller, when an operating speed change request is received from the system controller in response to the transmission of the outlier notification while controlling the storage device to operate in a first power state among a plurality of power states, may be configured to control the storage device to operate in a second power state having a lower operating speed than the first power state in response to the operation speed change request.

The memory controller may be configured to transmit at least one of command input/output history information or telemetry data of the storage device to the system controller in response to an information request related to the outlier notification when the information request is received from the system controller in response to the transmission of the outlier notification.

According to one or more embodiments, a method of operating a storage system including a plurality of storage devices includes storing a trap file in a trap area of each of the plurality of storage devices, controlling operations of the plurality of storage devices based on a plurality of commands received from a host, reducing an operating speed of a first storage device among the plurality of storage devices when an access to a trap area of the first storage device is detected, and performing a malware detection operation based on a predetermined number of commands, among the plurality of commands, corresponding to a time point at which the access to the trap area was detected.

Each of the plurality of storage devices may operate in one of a plurality of power states having different operating speeds, and the reducing of the operating speed may include modifying a power state of the first storage device.

The method may include storing information on the plurality of commands based on a sliding window having a predetermined size. The performing of the malware detection operation may include extracting a plurality of features from information on commands included in the sliding window at the time point at which an access to the trap area was detected and applying the extracted features to a malware detection algorithm based on machine learning to perform the malware detection operation.

The method may include providing information related to the access to the trap area to the host. The information related to the access to the trap area may include at least one of information on a group including the first storage device, information on storage devices included in the group, information on commands included in the sliding window at the time point at which the access to the trap area was detected, command input/output history information of the first storage device, or telemetry data of the first storage device.

### BRIEF DESCRIPTION OF DRAWINGS

FIG. 1 is a block diagram illustrating a configuration of a storage system according to one or more embodiments.

FIG. 2 is a block diagram illustrating a configuration of a system controller according to one or more embodiments.

FIG. 3 is a block diagram illustrating a configuration of a storage protection module according to one or more embodiments.

FIG. 4 is a table illustrating power states of a storage device according to one or more embodiments.

FIG. 5 is a diagram illustrating a malware detection operation of a system controller according to one or more embodiments.

FIG. 6 is a diagram illustrating an example of an operating speed reduction operation of the storage system according to one or more embodiments.

FIG. 7 is a block diagram illustrating a configuration of a storage device according to one or more embodiments.

FIG. 8 is a block diagram illustrating a configuration of a memory controller according to one or more embodiments.

FIG. 9 is a flowchart illustrating a method of operating a storage system according to one or more embodiments.

FIG. 10 is a flowchart illustrating the operation of the storage system according to one or more embodiments.

FIG. 11 is a block diagram illustrating a configuration of a data center according to one or more embodiments.

### DETAILED DESCRIPTION

In the present disclosure, the terms such as “first” and “second” as used herein may modify various elements regardless of an order and/or importance of the corresponding elements, and do not limit the corresponding elements. These terms may be used for the purpose of distinguishing one element from another element.

It will be understood that, when an element (for example, a first element) is “coupled with/to” or “connected to” another element (for example, a second element), the element may be directly coupled with/to another element, and there may be an intervening element (for example, a third element) between the element and another element.

Hereinafter, example embodiments will be described in detail to enable those skilled in the art to readily implement the present disclosure.

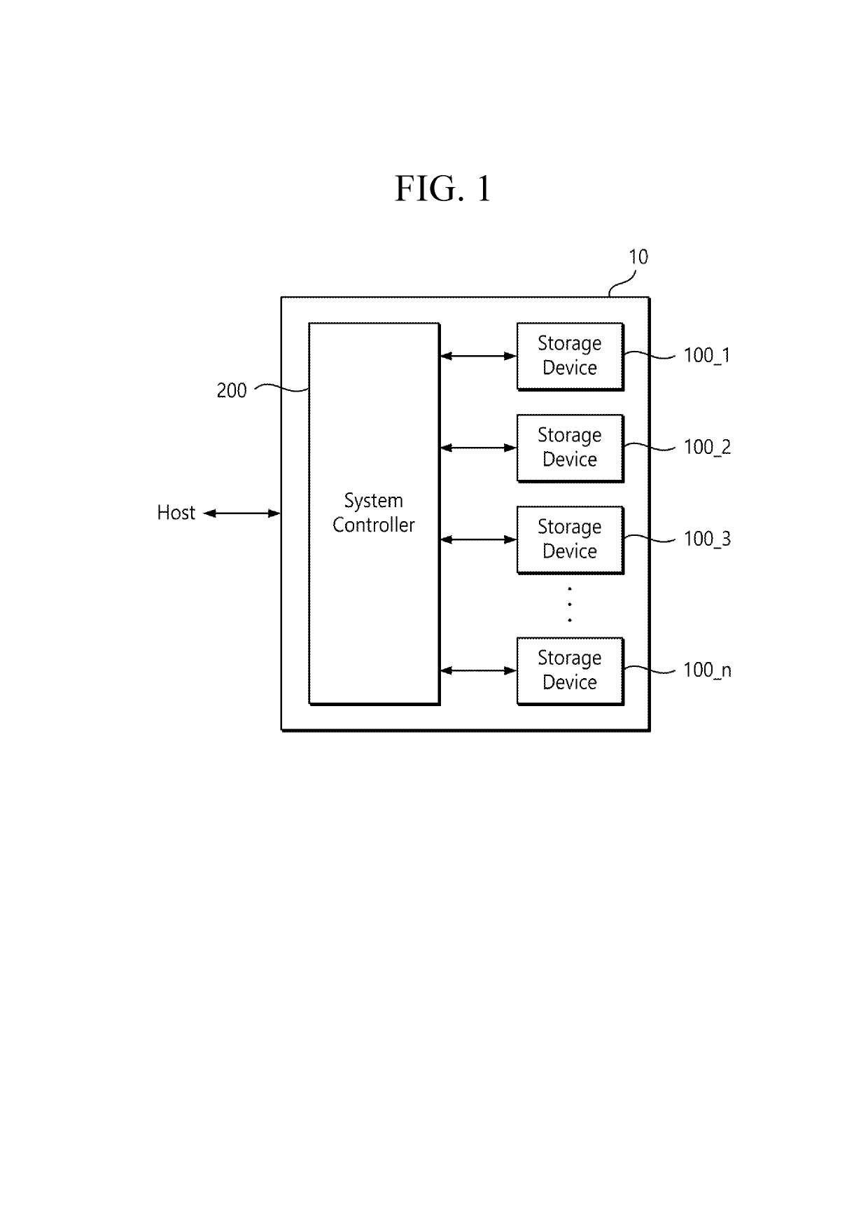

FIG. 1 is a block diagram illustrating a configuration of a storage system according to one or more embodiments. A storage system 10 may be a server or a data center used by a host or a host device, but embodiments are not limited thereto.

Referring to FIG. 1, the storage system 10 may include a system controller 200 and a plurality of storage devices 100_1 to 100_n.

The plurality of storage devices 100_1 to 100_n may be controlled by the system controller 200, and may store data transmitted from the host or provide stored data to the host.

Each of the plurality of storage devices 100_1 to 100_n may include a nonvolatile memory device storing data regardless of whether power is supplied. For example, the plurality of storage devices 100_1 to 100_n may be at least one of a solid state drive (SSD), an embedded memory, or a removable external memory. When the storage device is an SSD, the storage device may comply with the nonvolatile memory express (NVMe) standard. When the storage device is an embedded memory or an external memory, the storage device may comply with the universal flash storage (UFS) or embedded multimedia card (eMMC) standard.

When a nonvolatile memory device of a storage device includes a flash memory, the flash memory may include a 2D NAND memory array or a 3D (or vertical) NAND (VNAND) memory array. The storage device may also include various other types of nonvolatile memory devices. For example, the storage device may include a magnetic RAM (MRAM), a spin-transfer torque MRAM, a conductive bridging RAM (CBRAM), a ferroelectric RAM (FeRAM), a phase RAM (PRAM), a resistive RAM, or various other types of memory.

A portion of the plurality of storage devices 100_1 to 100_n may function as a boot disk for the operation of the storage system 10. The boot disk may store an operating system or various utility programs of the storage system 10 in the form of an ISO image.

In certain embodiments, each of the plurality of storage devices 100_1 to 100_n may store a trap file. The trap file may be generated by the host or the system controller 200 and provided to each storage device. In certain embodiments, the trap file may be generated to have a file name that may be searched ahead of a user file during a file search by malware, but embodiments are not limited thereto. The trap file may be stored in a predetermined area (hereinafter, “trap area”) of each storage device. The trap area may be different for each storage device, but embodiments are not limited thereto.

The trap file may be used to detect malicious access by an attacker. For example, each of the plurality of storage devices 100_1 to 100_n may set a trap area as a write protection area. An attempt to access the trap area may be regarded as an abnormal access, so that each of the plurality of storage devices 100_1 to 100_n may transmit an outlier notification to the system controller 200 based on an access to the trap area being detected.

The system controller 200 may control the plurality of storage devices 100_1 to 100_n. The system controller 200 may write data in the plurality of storage devices 100_1 to 100_n based on a plurality of commands received from the host, or read data stored in a plurality of storage devices 100_1 to 100_n and provide the read data to the host.

For example, the system controller 200 may perform a malware detection operation. Malware is malicious software designed to perform malicious actions such as destroying a system or modifying or leaking information against the user's interests, and may include computer viruses, Trojan horses, adware, cryptojackers, ransomware, or the like.

In certain embodiments, the system controller 200 may perform a malware detection operation based on the outlier notification being received from at least one of the plurality of storage devices 100_1 to 100_n. As described above, the outlier notification may be received from the storage device when an access to a trap area of the storage device is detected. The access to the trap area may be a malicious access by an attacker, but may also be an access caused by an operational error. Accordingly, the system controller 200 may perform a malware detection operation to determine whether the outlier notification is due to a malicious access by an attacker.

The system controller 200 may perform a malware detection operation based on a predetermined number of commands corresponding to a time point at which the outlier notification is received. In certain embodiments, when the system controller 200 controls the plurality of storage devices 100_1 to 100_n based on the commands received from the host, the system controller 200 may store the received commands based on a sliding window having a predetermined size. Accordingly, the system controller 200 may perform a malware detection operation using the commands corresponding to the time point at which the outlier notification is received. Commands constituting the malware have a sequence, so that malware detection performance may be sufficiently secured by performing the malware detection operation based on commands related to the command requesting an access to the trap area.

For example, in certain embodiments, the system controller 200 may perform a malware detection operation based on a predetermined number of commands when an outlier notification is received from a storage device, rather than performing a malware detection operation in real time on all commands received from a host. Accordingly, the performance degradation of the storage system 10 caused by the malware detection operation may be reduced compared to typical technology for performing a malware detection operation based on all commands in real time.

When receiving the outlier notification from at least one of the plurality of storage devices 100_1 to 100_n, the system controller 200 may reduce an operating speed of the corresponding storage device(s) and perform a malware detection operation.

The service provided by the storage system 10 may be maintained, regardless of the reduction in the operating speed of the storage devices. In addition, as the operating speed decreases, the system controller 200 may gain resource availability, allowing the above-mentioned malware detection operation to be performed without significantly degrading the performance of the storage system 10. In addition, when the received outlier notification is due to malware, the scope of malware infection may be significantly reduced.

In certain embodiments, the system controller 200 may provide information related to an outlier notification to the host. The information related to the outlier notification may include at least one of information on a group including a storage device in which an access to a trap area has been detected, information on a storage devices included in the group, information on commands included in a sliding window at a time point at which the access to the trap area has been detected, command input/output history information of the storage device in which the access to the trap area has been detected, or telemetry information of the storage device in which access to the trap area has been detected. This may help the host perform the follow-up actions.

As described above, according to one or more embodiments, a storage system that is more efficiently protected from malware without performance degradation may be provided.

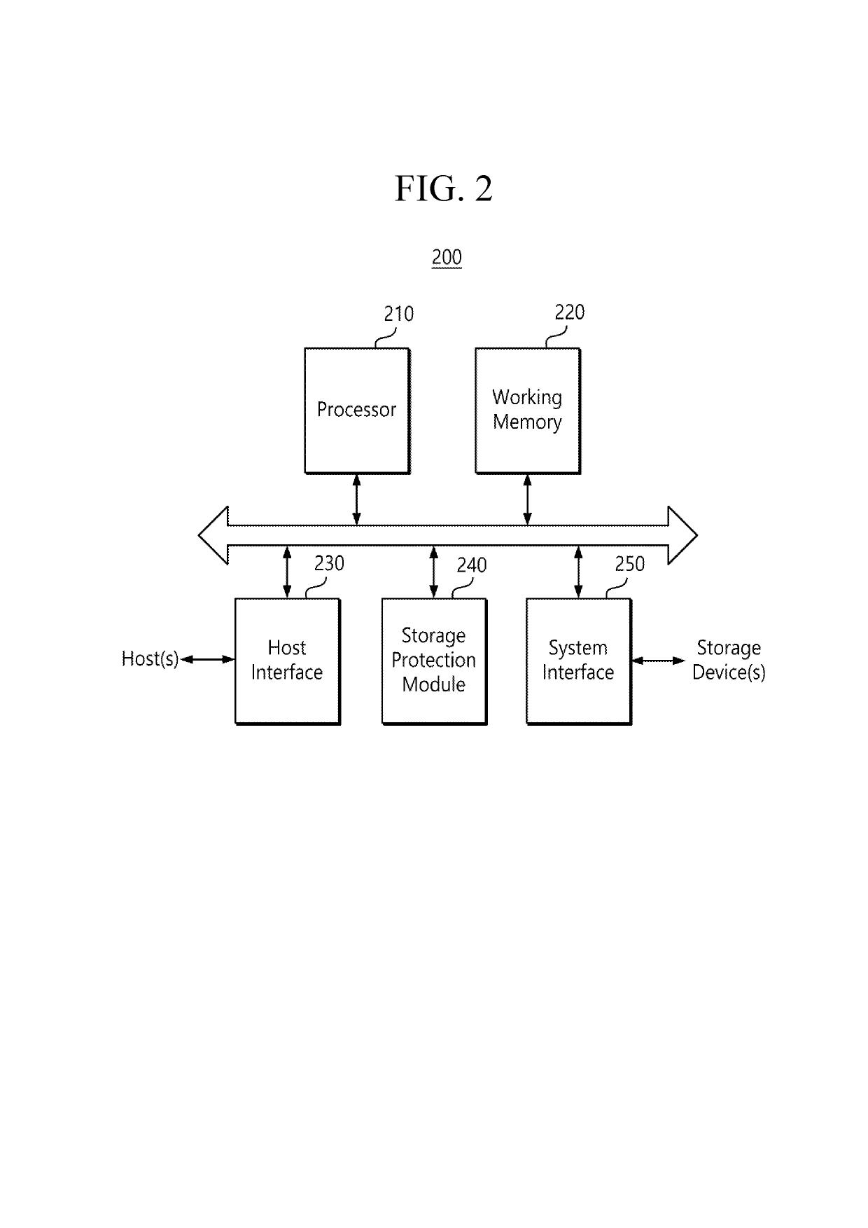

FIG. 2 is a block diagram illustrating a configuration of a system controller according to one or more embodiments. A system controller 200 of FIG. 2 may correspond to the system controller 200 of FIG. 1. Referring to FIG. 2, the system controller 200 may include a processor 210, a working memory 220, a host interface 230, a storage protection module 240, and a system interface 250.

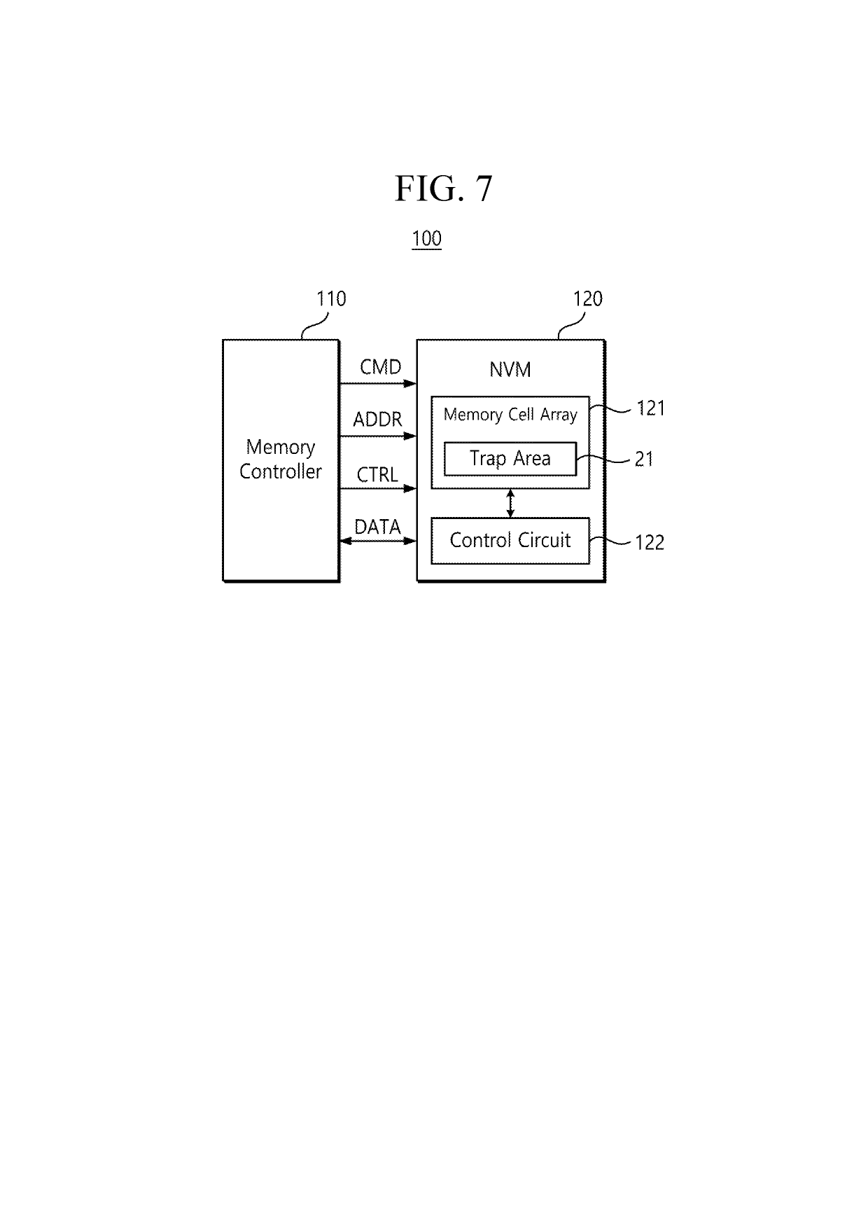

The processor 210 may include a central processing unit or a microprocessor. The processor 210 may drive firmware executed in the system controller 200. For example, the processor 210 may drive various types of firmware or software loaded into the working memory 220. In addition, the processor 210 may execute firmware or software responsible for core functions of a storage device 100 (see FIG. 7) such as a host interface layer (HIL) or a flash translation layer (FTL).

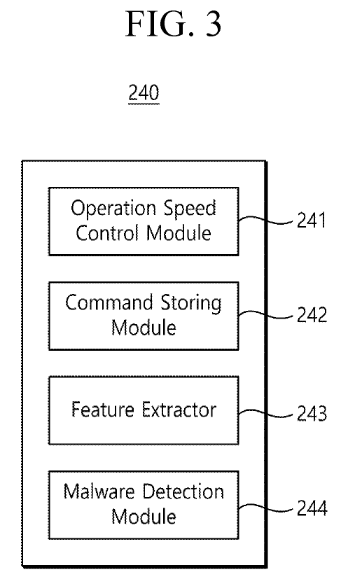

Software (or firmware) or data for controlling the system controller 200 may be loaded into the working memory 220. The software and data loaded into the working memory 220 may be driven or processed by the processor 210. For example, a flash translation layer (FTL), not illustrated, driven by the processor 210 may perform functions such as address mapping, garbage collection, or wear leveling. For example, the storage protection module 240 may be loaded into the working memory 220. The storage protection module 240 driven by the processor 210 may perform functions such as adjusting an operating speed of a storage device, storing commands, extracting features of commands, or detecting malware, as described later in FIG. 3.

The working memory 220 may include a volatile memory such as a static random access memory (SRAM), a dynamic RAM (DRAM), or a synchronous DRAM (SDRAM), and/or a nonvolatile memory such as a flash memory, a phase-change RAM (PRAM), a magneto-resistive RAM (MRAM), a resistive RAM (ReRAM), or a ferroelectric RAM (FRAM).

The host interface 230 may provide an interface between the host and the system controller 200. The host and the system controller 200 may be connected through one of various standardized interfaces. The standardized interfaces may include various interface methods such as advanced technology attachment (ATA), serial ATA (SATA), external SATA (e-SATA), small computer small interface (SCSI), serial attached SCSI (SAS), peripheral component Interconnection (PCI), PCI Express (PCIe), universal serial bus (USB), IEEE 1394, universal flash storage (UFS), embedded multimedia card (eMMC), NVMe, or the like.

The system interface 250 may provide an interface between the system controller 200 and the plurality of storage devices 100_1 to 100_n. For example, data or commands processed by the processor 210 may be transmitted to the plurality of storage devices 100_1 to 100_n through the system interface 250. In addition, data stored in the plurality of storage devices 100_1 to 100_n or signals generated in the plurality of storage devices 100_1 to 100_n may be transmitted to the system controller 200 through the system interface 250.

In certain embodiments, the above-described outlier notification may be provided to the system controller 200 through an asynchronous event. To this end, the system interface 250 may provide an asynchronous event interface between the system controller 200 and the plurality of storage devices 100_1 to 100_n.

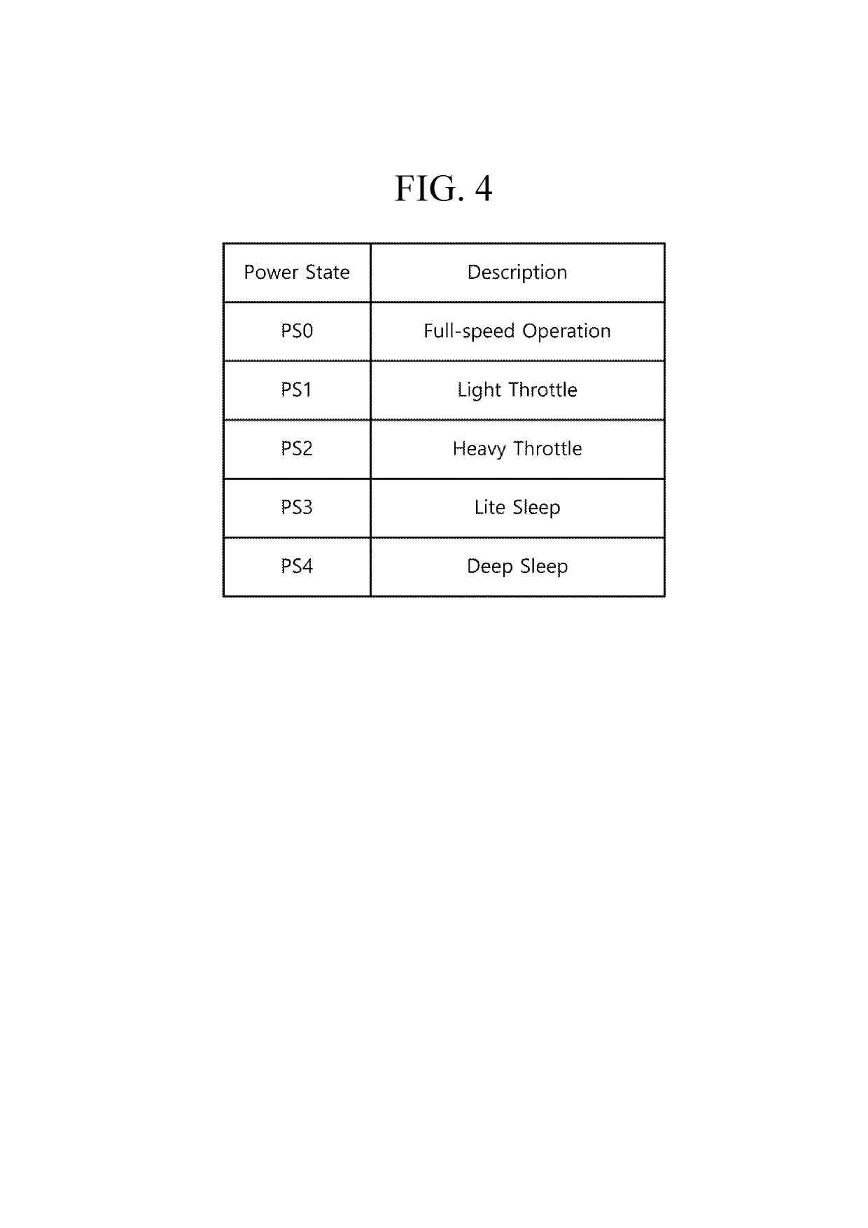

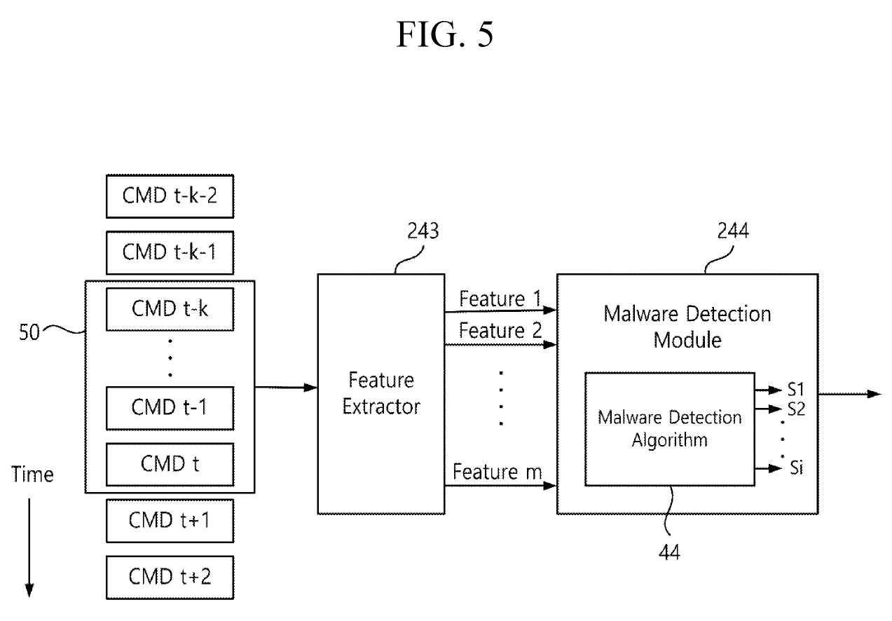

Hereinafter, the operation of the system controller 200 will be described in more detail with reference to FIGS. 3 to 5. FIG. 3 is a block diagram illustrating the configuration of a storage protection module according to one or more embodiments. FIG. 4 is a table illustrating power states of a storage device according to one or more embodiments. FIG. 5 is a diagram for explaining a malware detection operation of a system controller according to one or more embodiments.

The system controller 200 may perform the functions of components included in the storage protection module 240. Referring to FIG. 3, the storage protection module 240 may include an operating speed control module 241, a command storing module 242, a feature extractor 243, and a malware detection module 244.

The operating speed control module 241 may control an operating speed of the plurality of storage devices 100_1 to 100_n. In certain embodiments, the operating speed control module 241 may reduce the operating speed of at least one storage device when an outlier notification is received from at least one of the plurality of storage devices 100_1 to 100_n.

In certain embodiments, each of the plurality of storage devices 100_1 to 100_n may operate in a single power state, among five power states PS0, PS1, PS2, PS3 and PS4, as illustrated in FIG. 4. The storage device may have different speeds in the respective power state PS0, PS1, PS2, PS3 and PS4. In an example of FIG. 4, the storage device may operate at full speed in PS0, and an operating speed of the storage device may be gradually reduced through PS1, P2, P3, and P4.

When an outlier notification is received from at least one of the plurality of storage devices 100_1 to 100_n, the operating speed control module 241 may change a current power state of the storage device to a power state corresponding to a lower operating speed. In certain embodiments, when an outlier notification is received from the storage device 100_1 while all of the plurality of storage devices 100_1 to 100_n are operating at PS0, the operating speed control module 241 may control the power state of the storage device 100_1 to PS4 to reduce the operating speed of the storage device 100_1.

The command storing module 242 may store information on a predetermined number of commands among a plurality of commands received from the host. In certain embodiments, the command storing module 242 may store information on a plurality of commands received from the host based on a sliding window having a predetermined size. Referring to FIG. 5, the command storing module 242 may apply a sliding window 50 having a predetermined size to a plurality of commands CMD t-k-2 to CMD t+2 received from the host, and store information on commands CMD t-k to CMD t currently included in the sliding window 50.

The information on the commands may be included in metadata on each command. In certain embodiments, the information on the commands may include information on the type of each command and information related to a logical block address (LBA) corresponding to each command. For example, the information on the commands may include an OP code of each command, a starting logical block address (SLBA) of each command, the number of logical block (NLB) corresponding to each command, or a queue identifier (QID) of each command, but embodiments are not limited thereto.

The feature extractor 243 may extract a plurality of features from information on commands. In certain embodiments, when the outlier notification is received by the system controller 200, the feature extractor 243 may extract a plurality of features Feature 1 to Feature m from information on commands CMD t-k to CMD t included in the sliding window 50 at a current time point at which the outlier notification is received.

The plurality of features Feature 1 to Feature m extracted by the feature extractor 243 may be related to malware detection. For example, the plurality of features Feature 1 to Feature m may include a time difference between commands, a pattern of commands, a frequency appearing in commands, a difference between a minimum SLBA and a maximum SLBA, a percentage of read commands and write commands, a write volume of a write command, and information on whether a large command block is received at a short time interval, but embodiments are not limited thereto.

The malware detection module 244 may perform a malware detection operation based on the features Feature 1 to Feature m extracted from the feature extractor 243. In certain embodiments, the malware detection module 244 may apply the features Feature 1 to Feature m, extracted from the feature extractor 243, to a malware detection algorithm 44 based on machine learning to perform a malware detection operation.

For example, a malware detection algorithm 44 may output a score S1 to Si for each of a plurality of pieces of predefined malwares when the plurality of features extracted from the feature extractor 243 are input. Accordingly, when there is a malware item for which a score higher than a predetermined standard value is output, it may be determined that malware of the item has been detected.

To this end, the malware detection algorithm 44 may include at least one of a convolutional neural network, a recurrent neural network, a principal component analysis model, and a random forest model, and may be trained based on the plurality of predefined malware. The plurality of pieces of predefined malware may be malware whose commands constituting the corresponding malware are known. The malware detection algorithm 44 may be trained using features extracted from the commands constituting the known malware, and output similarity to the corresponding malware as a score when the features are input.

As described above, according to one or more embodiments, the system controller 200 may reduce an operating speed of at least one of the plurality of storage devices 100_1 to 100_n based on an outlier notification being received from the at least one storage device, and perform a malware detection operation based on information on a predetermined number of commands corresponding to a time point at which the outlier notification was received.

While an example has been provided in which the system controller 200 reduces the operating speed of the storage device that transmitted an outlier notification when receiving the outlier notification, but embodiments are not limited thereto.

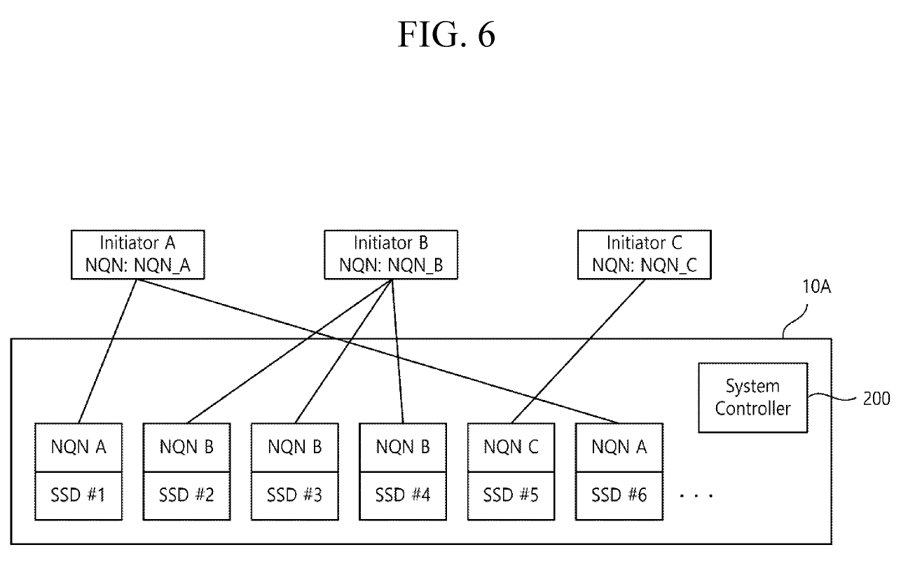

FIG. 6 is a diagram illustrating an example of an operating speed reduction operation of the storage system according to one or more embodiments. A storage system 10A of FIG. 6 may be an example of the storage system 10 of FIG. 1. In FIG. 6, Initiator represents a transmission subject and may correspond to a host. In addition, NQN represents an NVMe Qualified Name, and SSD represents a storage device.

In certain embodiments, the storage system 10 may be used by a plurality of hosts, and different storage devices may be allocated to each of the plurality of hosts. For example, a plurality of storage devices 100_1 to 100_n may include a plurality of groups divided for each host. When an outlier notification is received, the system controller 200 may reduce a speed of not only the storage device that transmitted the outlier notification, but also a speed of other storage devices included in a group to which the storage device belongs.

Referring to the example of FIG. 6, the storage system 10A may be used by Initiator A, Initiator B, and Initiator C, SSD #1 and SSD #6 may be assigned to Initiator A, SSD #2, SSD #3, and SSD #4 may be assigned to Initiator B, and SSD #5 may be assigned to Initiator C. For example, when an access to a trap area of SSD #3 occurs, SSD #3 may transmit an outlier notification to the system controller 200. The system controller 200 may reduce an operating speed of not only SSD #3 but also an operating speed of other SSDs (for example, SSD #2 and SSD #4) included in a group to which SSD #3 belongs, and perform the above-described malware detection operation.

As described above, according to one or more embodiments, an outlier may be detected in storage devices assigned to a single host (for example, Initiator B) while the storage system 10 provides a service in a multi-tenancy environment. In certain embodiments, the system controller 200 may reduce an operating speed of only the storage device (for example, SSD #3) in which the outlier was detected, and perform the above-described malware detection operation. In alternative embodiments, the system controller 200 may reduce the operating speed of all of the storage devices SSD #2, SSD #3, and SSD #4 in the group to which the storage device (for example, SSD #3) in which the outlier was detected belongs, and perform the above-described malware detection operation. Accordingly, the malware detection operation may be performed without affecting the service provided to other hosts (for example, Initiator A and Initiator C).

However, one or more embodiments are not limited thereto. For example, when an outlier notification is received from at least one of the plurality of storage devices 100_1 to 100_n, the system controller 200 may reduce the operating speed of all of the storage devices 100_1 to 100_n in the storage system 10 and perform the above-described malware detection operation.

In certain embodiments, the system controller 200 may provide information related to outlier notification to the host. For example, the system controller 200 may perform the above-described malware detection operation and then provide information related to outlier notification to the host along with the detection result.

The information related to the outlier notification may include at least one of information on a group including a storage device that transmitted the outlier notification, information on storage devices included in the group, information on commands included in the sliding window 50 at a time point at which the outlier notification was received, command input/output history information of the storage device that transmitted the outlier notification, and telemetry information of the storage device that transmitted the outlier notification. To this end, in certain embodiments, the system controller 200 may request and obtain command input/output history information and telemetry information corresponding to the time point at which the outlier notification was transmitted from the storage device that transmitted the outlier notification.

The information related to the outlier notification transmitted to the host may be used for subsequent operations of the host related to malware. For example, when the storage system 10 is infected with malware, the host may use the information related to the outlier notification to determine follow-up actions. For example, information on commands included in the sliding window 50 at the time point at which the outlier notification is received may include key information used for an encryption operation of the ransomware. The host may perform the follow-up actions using the key information.

FIG. 7 is a block diagram illustrating a configuration of a storage device according to one or more embodiments. A storage device 100 of FIG. 7 may correspond to each of the plurality of storage devices 100_1 to 100_n of FIG. 1, but embodiments are not limited thereto.

Referring to FIG. 7, the storage device 100 may include a memory controller 110 and a nonvolatile memory device (NVM) 120.

The memory controller 110 may control the overall operation of the storage device 100. For example, the memory controller 110 may control program, read, and erase operations of the nonvolatile memory device 120 by providing an address ADDR, a command CMD, and a control signal CTRL to the nonvolatile memory device 120 in response to a request from a host transmitted through the system controller 200. The memory controller 110 may store data, received through the system controller 200, in the nonvolatile memory 120 or read data stored in the nonvolatile memory 120.

In certain embodiments, the memory controller 110 may store a trap file, transmitted through the system controller 200, in a trap area 21 of the nonvolatile memory device 120.

In addition, when an access to the trap area 21 is detected, the memory controller 110 may generate an outlier notification. For example, the memory controller 110 may set a logical block address (LBA) range corresponding to the trap area as a write protection area. Accordingly, when an access to the write protection area is detected, the memory controller 110 may generate an outlier notification and transmit the generated outlier notification to the system controller 200. The outlier notification may be transmitted to the system controller 200 through an asynchronous event, but embodiments are not limited thereto.

In certain embodiments, the memory controller 110 may control a power state of the storage device 100. For example, the storage device 100 may have a plurality of power states (for example, see FIG. 4). The plurality of power states may have different operating speeds. The memory controller 110 may receive an operating speed change request from the system controller 200 while controlling the storage device 100 to operate in a first power state among the plurality of power states. The operating speed change request may be received from the system controller 200 in response to transmission of the outlier notification.

The memory controller 110 may control the storage device 100 to operate in a second power state having a lower operating speed than the first power state in response to the received operating speed change request.

The memory controller 110 may provide information related to an outlier notification to the system controller 200. For example, the memory controller 110 may receive a request for the information related to an outlier notification from the system controller 200. The memory controller 110 may transmit at least one of command input/output history information and telemetry information of the nonvolatile memory device 120 to the system controller 200 in response to the received request for information.

In certain embodiments, the memory controller 110 may temporarily store commands and data transmitted through the system controller 200. Accordingly, the memory controller 110 may provide commands and data corresponding to a time point, at which the outlier notification was transmitted, to the system controller 200 in response to the information request.

In addition, the memory controller 110 may store telemetry information generated while controlling the operation of the nonvolatile memory device 120. The telemetry information may include information related to an error correction operation of the nonvolatile memory device 120 (for example, uncorrectable error correction code UECC) data, correctable error correction code (CECC) data, or the like, but embodiments are not limited thereto. Accordingly, the memory controller 110 may provide telemetry information corresponding to the time point, at which an outlier notification is transmitted to the system controller 200, in response to the information request.

The nonvolatile memory device 120 may program data received from a memory controller 110 or transmit stored data to the memory controller 110 under the control of the memory controller 110.

The nonvolatile memory device 120 may include a memory cell array 121 and a control circuit 122. The memory cell array 121 may include a plurality of memory blocks. Each memory block may include a plurality of pages, and each page may include a plurality of memory cells. Each of the plurality of memory cells may be connected to wordlines WL and bitlines BL. In certain embodiments, each of the plurality of memory cells may be used as a single level cell (SLC), a multilevel cell (MLC), a triple level cell (TLC), a quad level cell QLC, or the like. Each of the plurality of memory cells may be implemented as various nonvolatile memory elements such as a NAND flash memory, a NOR flash memory, a phase change RAM (PRAM), a resistive RAM (ReRAM), a magnetic RAM (MRAM), a ferroelectric RAM (FRAM), or the like. In certain embodiments, each of the plurality of memory cells may be implemented in a three-dimensional array structure such as a vertical NAND flash memory (VNAND), but embodiments are not limited thereto.

For example, in certain embodiments, the memory cell array 121 may include a trap area 21. The trap area 21 may be an area in which a trap file transmitted through the system controller 200 is stored. As described above, a logical block address (LBA) range corresponding to the trap area 21 may be set as a write protection area.

In certain embodiments, the trap file may be stored in a folder that may be searched first by malware. For example, the trap file may be stored in a trap folder formed in an uppermost path route of the nonvolatile memory device 120. The trap folder may have a folder name that may be searched first by malware. However, embodiments are not limited thereto, and the trap file may be stored in an arbitrary area within a user area of the memory cell array 121.

The control circuit 122 may control the overall operation of the nonvolatile memory device 120. The control circuit 122 may include various analog circuits or digital circuits necessary to store data in the memory cell array 121 or read data from the memory cell array 121. The control circuit 122 may store data DATA in the memory cell array 121 or read data stored in the memory cell array 121 and provide the stored data DATA to the memory controller 110 based on a command CMD, an address ADDR, and a control signal CTRL received from the memory controller 110.

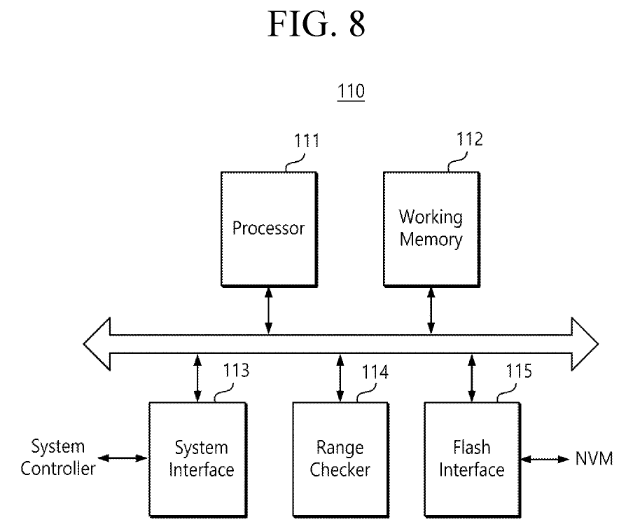

FIG. 8 is a block diagram illustrating a configuration of a memory controller according to an example embodiment. A memory controller 110 of FIG. 8 may correspond to the memory controller 110 of FIG. 7. Referring to FIG. 8, the memory controller 110 may include a processor 111, a working memory 112, a system interface 113, a range checker 114, and a flash interface 115.

The processor 111 may include a central processing unit or a microprocessor. The processor 111 may drive firmware executed in the memory controller 110. For example, the processor 111 may drive various types of firmware or software loaded into the working memory 112. In addition, the processor 111 may execute firmware or software, responsible for core functions of the storage device 100, such as a host interface layer (HIL) or a flash translation layer (FTL).

Software (or firmware) or data for controlling the memory controller 110 may be loaded into the working memory 112. The software and data loaded into the working memory 112 may be driven or processed by the processor 111. For example, a flash translation layer (FTL), not illustrated, driven by the processor 111 may perform functions such as address mapping, garbage collection, or wear leveling.

In certain embodiments, the working memory 112 may temporarily store commands and data transmitted through the system controller 200. In addition, the working memory 112 may store telemetry information generated during the operation of the nonvolatile memory device 120.

The working memory 112 may include a volatile memory such as static random access memory (SRAM), a dynamic RAM (DRAM), a synchronous DRAM (SDRAM), and/or a nonvolatile memory such as a flash memory, a phase-change RAM (PRAM), a magneto-resistive RAM (MRAM), a resistive RAM (ReRAM), a ferroelectric RAM (FRAM), or the like.

The range checker 114 may perform various system lock operations on the nonvolatile memory device 120. For example, in a system lock state, the nonvolatile memory device 120 may be blocked from an access for a predetermined period of time. Alternatively, in the system lock state, the nonvolatile memory device 120 may operate in a read-only mode. Alternatively, in the system lock state, a specific area of the memory cell array 121 may be blocked from access. Alternatively, in the system lock state, a specific area of the memory cell array 121 may operate in a read-only mode. The range checker 114 may generate an error signal when an operation prohibited by the system lock is attempted.

For example, in certain embodiments, the range checker 114 may set a logical block address (LBA) range corresponding to the trap area 21 as a write protection area, and may generate an outlier notification when an access to the write protection area is detected. The outlier notification may be a type of the error signal and may be transmitted to the system controller 200 through an asynchronous event.

The system interface 113 may provide an interface between the memory controller 110 and the system controller 200. In certain embodiments, the system interface 113 may provide an asynchronous event interface between the memory controller 110 and the system controller 200 to transmit an outlier notification to the system controller 200. In addition, in certain embodiments, the memory controller 110 may receive an information request or an operating speed change request related to the outlier notification from the system controller 200 through the system interface 113.

For example, when a request for information related to an outlier notification is received, the memory controller 110 may transmit at least one of command input/output history information and telemetry information to the nonvolatile memory device 120 through the system interface 113.

In addition, when a request to change the operating speed is received, the memory controller 110 may control the operation of the storage device 100 by changing the power state to a power state having a lower operating speed than a current power state.

The flash interface 115 may provide an interface between the memory controller 110 and the nonvolatile memory device 120. The memory controller 110 may transmit commands or data to the nonvolatile memory device 120 or receive data from the nonvolatile memory device 120 through the flash interface 115.

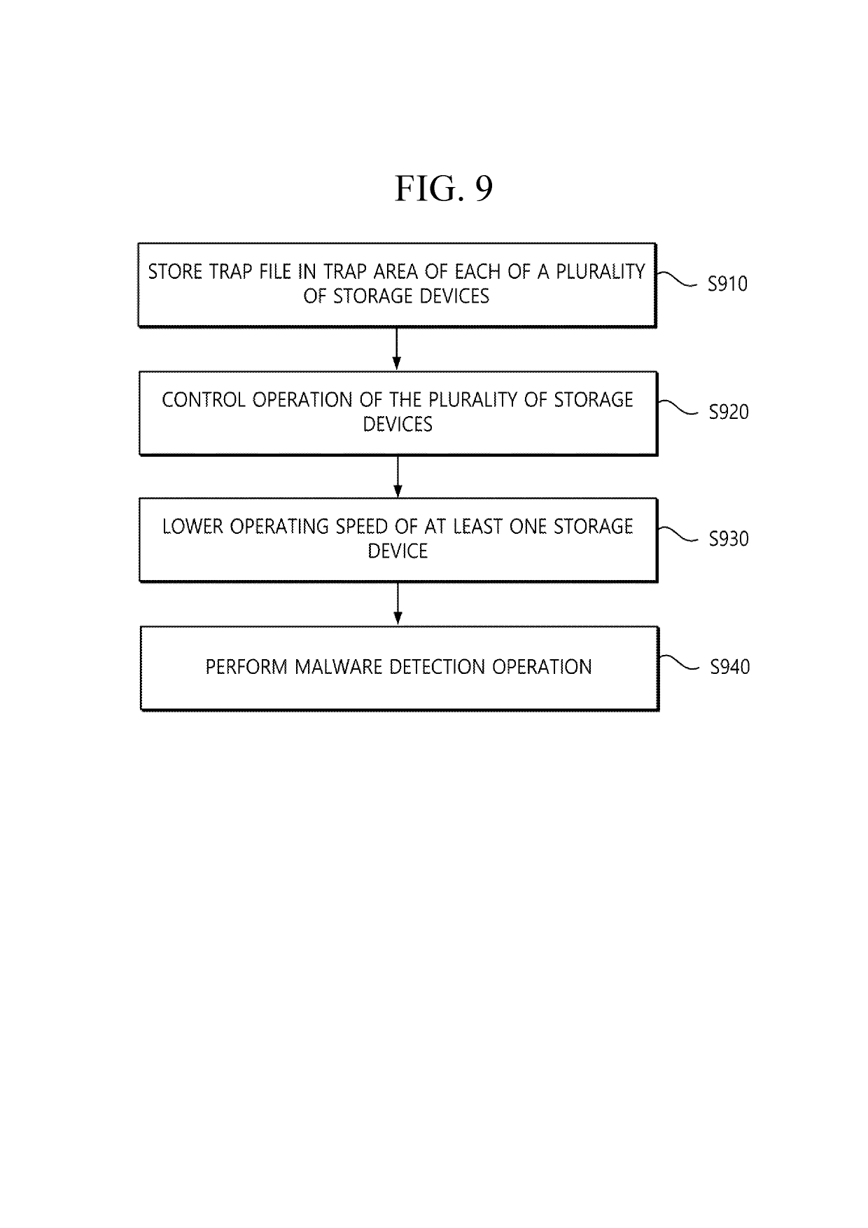

FIG. 9 is a flowchart illustrating an operating method of a storage system according to an embodiment of the present invention. The storage system whose operating method is described in FIG. 9 may correspond to the storage systems 10 and 10A of FIGS. 1 and 6. Descriptions of features identical or similar to those in the above embodiments are omitted to avoid redundancy.

Referring to FIG. 9, in operation S910, the storage system 10 may store a trap file in the trap area 21 of each of the plurality of storage devices 100_1 to 100_n. The trap area 21 may be different for each storage device, but embodiments are not limited thereto.

In operation S920, the storage system 10 may control the operation of the plurality of storage devices 100_1 to 100_n based on the plurality of commands received from the host. The storage system 10 may store information on the plurality of commands based on a sliding window 50 having a predetermined size.

In operation S930, the storage system 10 may reduce an operating speed of at least one storage device when an access to the trap area of at least one of the plurality of storage devices 100_1 to 100_n is detected.

For example, each of the plurality of storage devices 100_1 to 100_n may operate in one of a plurality of power states having different operating speeds. Accordingly, the storage system 10 may change a power state of the at least one storage device to reduce the operating speed of the at least one storage device.

In operation S940, the storage system 10 may perform a malware detection operation based on a predetermined number of commands corresponding to a time point at which an access to the trap area 21 is detected, among the plurality of commands received from the host.

For example, the storage system 10 may extract a plurality of features from information on commands included in the sliding window 50 at the time point at which the access to the trap area 21 is detected, and apply the extracted features to a malware detection algorithm based on machine learning to perform a malware detection operation.

In certain embodiments, the storage system 10 may provide the host with information related to access to the trap area 21. The information related to the access to the trap area may include at least one of information on a group including the at least one storage device, information on storage devices included in the group, information on commands included in the sliding window 50 at the time point at which the access to the trap area 21 is detected, command input/output history information of the at least one storage device, and telemetry information of the at least one storage device.

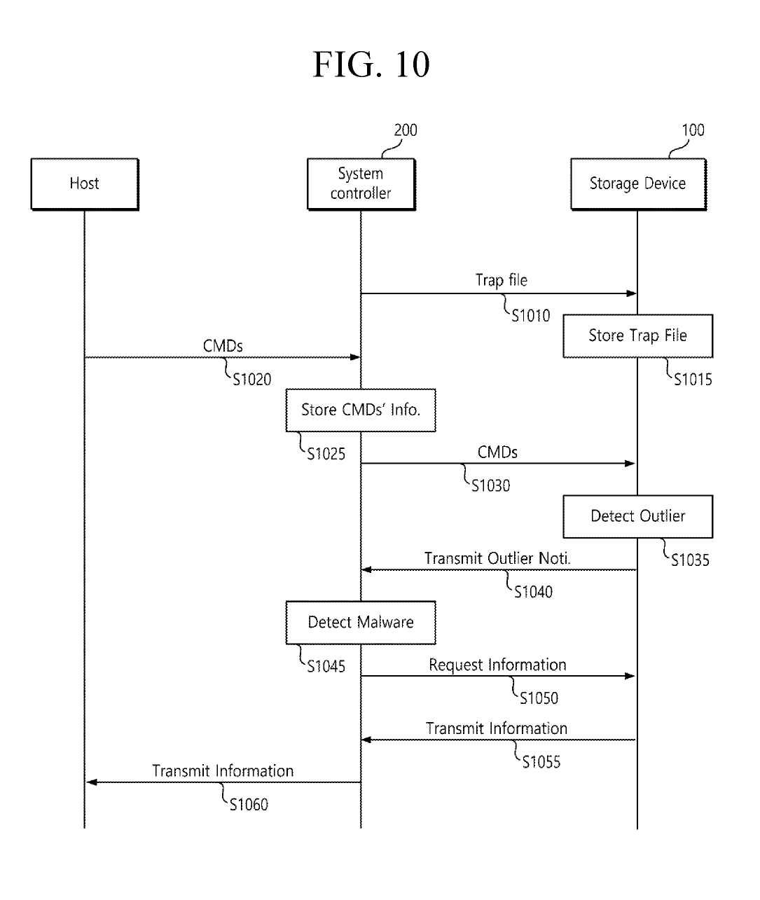

FIG. 10 is a flowchart illustrating the operation of the storage system according to one or more embodiments. The storage system whose operation method is described in FIG. 10 may correspond to the storage system 10 and 10A of FIG. 1 and FIG. 6. Descriptions of features identical or similar to those in the above embodiments are omitted to avoid redundancy.

Referring to FIG. 10, in operation S1010, the system controller 200 may transmit a trap file to the storage device 100. The trap file may be generated by the host and provided by the host. In certain embodiments, the trap file may be generated by the system controller 200.

In operation S1015, the storage device 100 may store the received trap file in the trap area 21. The storage device 100 may set an LBA range corresponding to the trap area 21 as a write protection area.

In operation S1020, the host may transmit a plurality of commands to the system controller 200. Accordingly, in operation S1025, the system controller 200 may store information on the plurality of commands received from the host. In certain embodiments, the system controller 200 may store information on the plurality of commands based on a sliding window 50 having a predetermined size.

In operation S1030, the system controller 200 may transmit the plurality of commands received from the host to the storage device 100 and perform operations corresponding to the plurality of commands.

In operation S1035, when an access to the trap area 21 is detected while performing the operations corresponding to the plurality of commands, the storage device 100 may detect an outlier and generate an outlier notification. Accordingly, in operation S1040, the storage device 100 may transmit the outlier notification to the system controller 200. The outlier notification may be transmitted through an asynchronous event.

In operation S1045, the system controller 200 that has received the outlier notification may perform a malware detection operation. In certain embodiments, the system controller 200 may perform a malware detection operation based on information on commands included in the sliding window 50 at a time point at which the outlier notification is received.

For example, the system controller 200 may extract a plurality of features from the information on commands included in the sliding window 50 at the time point at which the outlier notification is received, and perform a malware detection operation by applying the extracted plurality of features to a machine learning-based malware detection algorithm.

When the extracted features are input to a malware detection algorithm, the malware detection algorithm may output similarity for each of a plurality of pieces of predefined malware as a score. Accordingly, it may be determined whether the outlier detected in the storage device 100 is due to genuine malware infection.

In operation S1050, the system controller 200 may request information related to the outlier notification from the storage device 100. In operation S1055, the storage device 100 may transmit information related to outlier notification to the system controller 200.

In operation S1060, the system controller 200 may provide information related to the outlier notification to the host. A result of the malware detection operation may also be provided to the host. Accordingly, the host may perform follow-up actions using the information related to the outlier notification.

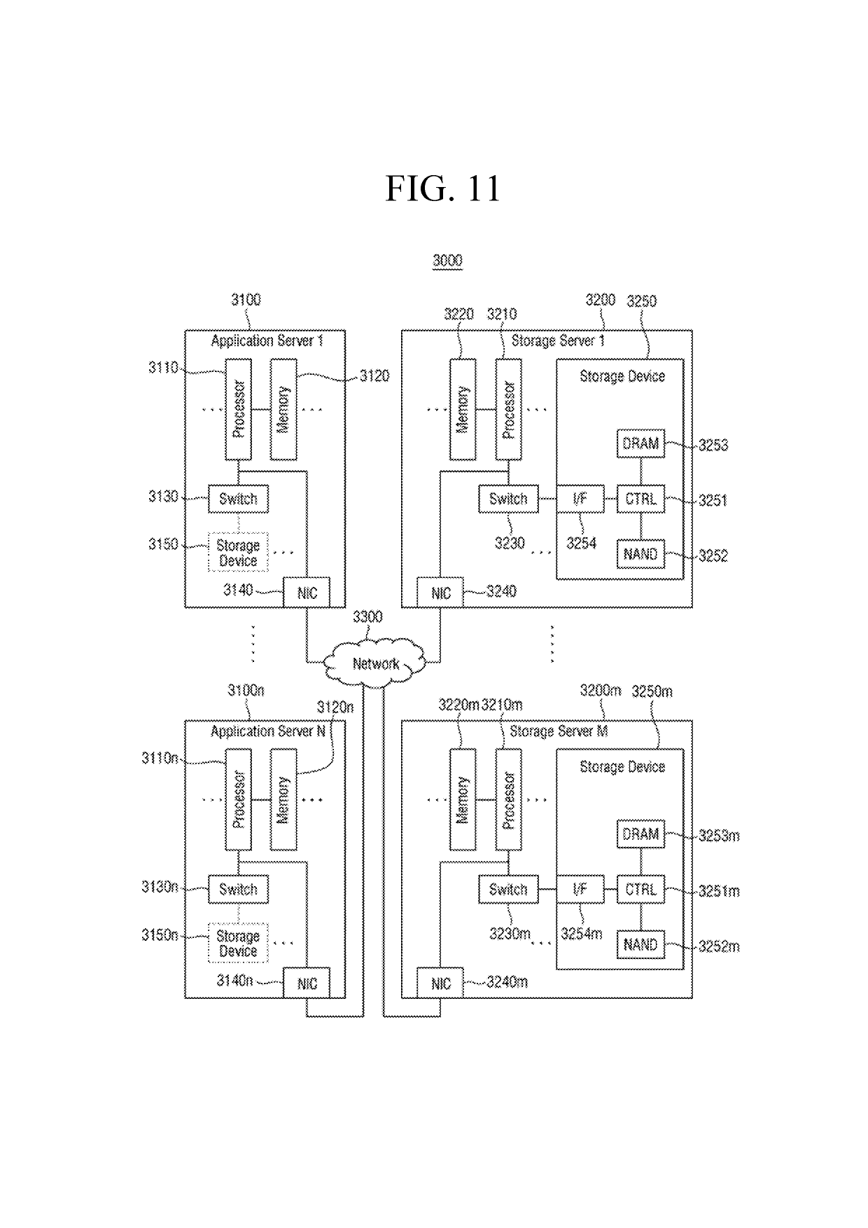

FIG. 11 is a block diagram illustrating a configuration of a data center according to one or more embodiments. Referring to FIG. 11, a data center 3000 is a facility that collects various types of data and provides services, and may also be referred to as a data storage center. The data center 3000 may be a system for operating a search engine and a database, and may be a computing system used by a company such as a bank or a government agency. The data center 3000 may include application servers 3100 to 3100n and storage servers 3200 to 3200m. The number of application servers 3100 to 3100n and the number of storage servers 3200 to 3200m may be variously selected according to one or more embodiments, and the number of application servers 3100 to 3100n and the number of storage servers 3200 to 3200m may be different from each other.

The application server 3100 or the storage server 3200 may include at least one of a processor 3110 or 3210 and a memory 3120 or 3220, respectively. For example, in the storage server 3200, the processor 3210 may control the overall operation of the storage server 3200 and may access the memory 3220 to execute commands and/or data loaded into the memory 3220. The memory 3220 may be a Double Data Rate Synchronous DRAM (DDR SDRAM), a High Bandwidth Memory (HBM), a Hybrid Memory Cube (HMC), a Dual In-line Memory Module (DIMM), an Optane DIMM, and/or a Non-Volatile DIMM (NVMDIMM). The number of processors 3210 and the number of memories 3220 included in the storage server 3200 may be variously selected according to one or more embodiments. In certain embodiments, the processor 3210 and the memory 3220 may provide a processor-memory pair. In certain embodiments, the numbers of the processors 3210 and the number of the memories 3220 may be different from each other. The processor 3210 may include a single core processor or a multicore processor. The above description of the storage server 3200 may be similarly applied to the application server 3100. In certain embodiments, the application server 3100 may not include the storage device 3150. The storage server 3200 may include at least one storage device 3250. The number of the storage devices 3250 included in the storage server 3200 may be variously selected according to one or more embodiments.

In certain embodiments, the storage server 3200 may correspond to the storage system 10 of FIG. 1. In addition, the storage device 3250 may correspond to one of the storage devices 100_1 to 100_n of FIG. 1 or the storage device 100 of FIG. 7. In addition, the processor 3210 and the memory 3220 may correspond to the processor 210 and the working memory 220 of FIG. 2, respectively.

For example, the NAND flash memory 3252 may independently combine commands from the controller 3251 and adjust the processing order of the commands.

The application servers 3100 to 3100n and the storage servers 3200 to 3200m may communicate with each other through the network 3300. The network 3300 may be implemented using Fibre Channel (FC), Ethernet, or the like. FC is a medium used for relatively high-speed data transmission, and an optical switch providing high performance/high availability may be used. Depending on an access method of the network 1300, the storage servers 3200 to 3200m may be provided as a file storage, a block storage, or an object storage.

In certain embodiments, the network 3300 may be a storage-specific network, such as a storage area network (SAN). For example, the SAN may be an FC-SAN using an FC network and implemented based on an FC protocol (FCP). For example, the SAN may be an IP-SAN using a TCP/IP network and implemented based on SCSI over TCP/IP or Internet SCSI protocol (iSCSI). In certain embodiments, the network 1300 may be a general network such as a TCP/IP network. For example, the network 1300 may be implemented based on a protocol such as FC over Ethernet (FCoE), Network Attached Storage (NAS), or NVMe over Fabrics (NVMe-oF).

Hereinafter, a description will be provided while focusing on the application server 3100 and the storage server 3200. The description of the application server 3100 may also be applied to other application servers 3100n, and the description of the storage server 3200 may also be applied to other storage servers 3200m.

The application server 3100 may store data requested to be stored by a user or client in one of the storage servers 3200 to 3200m through the network 3300. In addition, the application server 3100 may obtain data requested to be read by a user or client from one of the storage servers 3200 to 3200m through the network 3300. For example, the application server 3100 may be implemented as a web server or a database management system (DBMS).

The application server 3100 may access a memory 3120n or a storage device 3150n included in another application server 3100n via the network 3300, or may access memories 3220 to 3220m or storage devices 3250 to 3250m included in the storage servers 3200 to 3200m via the network 3300. Accordingly, the application server 3100 may perform various operations on data stored in the application servers 3100 to 3100n and/or the storage servers 3200 to 3200m. For example, the application server 3100 may execute a command to move or copy data between the application servers 3100 to 3100n and/or the storage servers 3200 to 3200m. The data may be moved from the storage devices 3250 to 3250m of the storage servers 3200 to 3200m to the memories 3220 to 3220m of the storage servers 3200 to 3200m, or directly moved to the memories 3120 to 3120n of the application servers 3100 to 3100n. The data moved through the network 3300 may be encrypted data for security or privacy.

For example, in the storage server 3200, the interface 3254 may provide a physical connection between the processor 3210 and the controller 3251 and a physical connection between a network interconnect (NIC) 3240 and a controller 3251. For example, the interface 3254 may be implemented in a direct attached storage (DAS) manner that directly connects the storage device 3250 with a specific-purpose cable. In addition, for example, the interface 3254 may be implemented in various interface modes such as an Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVM express (NVMe), IEEE 1394, universal serial bus (USB), secure digital (SD) card, multimedia card (MMC), embedded multimedia card (eMMC), Universal Flash Storage (UFS), embedded Universal Flash Storage (eUFS), and/or compact flash (CF) card interface.

The storage server 3200 may further include a switch 3230 and a NIC 3240. The switch 3230 may selectively connect the processor 3210 and the storage device 3250 or selectively connect the NIC 3240 and the storage device 3250 under the control of the processor 3210.

In certain embodiments, the NIC 3240 may include a network interface card, a network adapter, or the like. The NIC 3240 may be connected to the network 3300 via a wired interface, a wireless interface, a Bluetooth interface, an optical interface, or the like. The NIC 3240 may include internal memory, a digital signal processor (DSP), a host bus interface, or the like, and may be connected to the processor 3210 and/or the switch 3230 via the host bus interface. The host bus interface may be implemented as one of the above-described examples of the interface 3254. In certain embodiments, the NIC 3240 may be integrated with at least one of the processor 3210, the switch 3230, and the storage device 3250.

In storage servers 3200 to 3200m or the application servers 3100 to 3100n, a processor may transmit a command to storage devices 3150 to 3150n and 3250 to 3250m or the memories 3120 to 3120n and 3220 to 3220m to program or read data. The data may be error-corrected through an error correction code (ECC) engine. The data may be data processed by data bus inversion (DBI) or data masking (DM) and may include cyclic redundancy code (CRC) information. The data may be encrypted for security or privacy.

The storage devices 3150 to 3150n and 3250 to 3250m may transmit a control signal and a command/address signal to NAND flash memory devices 3252 to 3252m in response to a read command received from the processor. Accordingly, when data is read from the NAND flash memory devices 3252 to 3252m, a read enable signal RE may be input as a data output control signal and serve to output data to a DQ bus. A data strobe DQS may be generated using the read enable signal RE. The command and address signals may be latched in a page buffer according to a rising edge or falling edge of a write enable signal WE.

In certain embodiments, the controller 3251 may correspond to the processor 111 of FIG. 8, and the DRAM 3253 may correspond to the working memory 112 of FIG. 8. In addition, the NAND flash 3252 may correspond to the nonvolatile memory device 120 of FIG. 7.

The controller 3251 may control overall operation of the storage device 3250. In certain embodiments, the controller 3251 may include a static random access memory (SRAM). The controller 3251 may write data in the NAND flash 3252 in response to a write command, or may read data from the NAND flash 3252 in response to a read command. For example, the write command and/or the read command may be provided from the processor 3210 in the storage server 3200, the processor 3210m in another storage server 3200m, or the processors 3110 and 3110n in the application servers 3100 and 3100n. The DRAM 3253 may temporarily store (for example, buffer) data to be written in the NAND flash 3252 or data read from the NAND flash 3252. In addition, the DRAM 3253 may store metadata. The metadata may be data generated by the controller 3251 to manage the NAND flash memory 3252. The storage device 3250 may include a secure element SE for security or privacy.

According to above-described various embodiments, a storage system that is more efficiently protected from malware without performance degradation may be provided.

Various embodiments may be implemented as software including commands stored in a machine-readable storage media that can be read by machines (for example, computers). The machines refer to apparatuses that are capable of calling instructions stored in storage media and can operate based on the called instructions, and may include the system controller 200 or the memory controller 110 according to the above-described embodiments.

When an instruction is executed by a processor, the processor may perform a function corresponding to the instruction by itself, or by using other components under the control of the processor. An instruction may include a code generated or executed by a compiler or an interpreter. A storage medium that is readable by machines may be provided in the form of a non-transitory storage medium. The term "non-transitory" only means that a storage medium does not include signals, and is tangible, but does not indicate whether data is stored in the storage medium semi-permanently or temporarily.

In certain embodiments, the method according to the above-described various embodiments may be provided as included in a computer program product. The computer program product may be traded between sellers and buyers as a commodity. The computer program product may be distributed in the form of a machine-readable storage medium, or online through an application store. In the case of online distribution, at least a part of the computer program product may be temporarily stored or temporarily generated in a storage medium such as a memory of a manufacturer's server, a server of an application store, or a relay server.

As set forth above, a storage system which are more efficiently protected from malware without performance degradation may be provided.

While example embodiments have been shown and described above, it will be apparent to those skilled in the art that modifications and variations could be made without departing from the scope of the present inventive concept as defined by the appended claims.

What is claimed is:

1. A storage system comprising:
a plurality of storage devices, each configured to store a trap file; and
a system controller configured to control the plurality of storage devices based on a plurality of commands received from a host,
wherein:
the system controller is configured to reduce an operating speed of at least one storage device among the plurality of storage devices based on an outlier notification being received from the at least one storage device, and perform a malware detection operation based on commands corresponding to the outlier notification, among the plurality of commands; and
the at least one storage device is configured to transmit the outlier notification to the system controller based on an access to a trap area, in which the trap file is stored, being detected.

2. The storage system of claim 1, wherein:
each of the plurality of storage devices is configured to set a logical block address (LBA) range corresponding to the trap area as a write protection area, and transmit the outlier notification to the system controller when an access to the write protection area is detected.

3. The storage system of claim 2, wherein:
each of the plurality of storage devices is configured to transmit the outlier notification to the system controller via an asynchronous event.

4. The storage system of claim 1, wherein:
each of the plurality of storage devices operates in one of a plurality of power states having different operating speeds; and
the system controller is configured to modify a power state of the at least one storage device to reduce an operating speed of the at least one storage device.

5. The storage system of claim 1, wherein:
the system controller is configured to reduce operating speeds of the plurality of storage devices based on the outlier notification being received from the at least one storage device.

6. The storage system of claim 1, wherein:
the plurality of storage devices comprise a first group used by a first host and a second group used by a second host;
the first group comprises the at least one storage device and additional storage devices; and
the system controller is configured to reduce operating speeds of storage devices included in the first group based on the outlier notification being received from the at least one storage device.

7. The storage system of claim 1, wherein:
the system controller is configured to store information on the plurality of commands based on a sliding window having a predetermined size, and perform the malware detection operation based on information on commands included in the sliding window when the outlier notification is received.

8. The storage system of claim 7, wherein:
the information on the commands comprises information on a type of each command and information and logical block address (LBA) information corresponding to each command.

9. The storage system of claim 7, wherein:
the system controller is configured to extract a plurality of features from the information on command included in the sliding window when the outlier notification is received, and apply the extracted features to a malware detection algorithm based on machine learning to perform the malware detection operation; and
the malware detection algorithm comprises at least one of a convolutional neural network, a recurrent neural network, a principal component analysis model, or a random forest model.

10. The storage system of claim 9, wherein:
the malware detection algorithm is configured to output a score for each of a plurality of pieces of predefined malware based on the extracted features.

11. The storage system of claim 7, wherein:
the system controller is configured to provide information related to the outlier notification to the host.

12. The storage system of claim 11, wherein:
the information related to the outlier notification comprises at least one of (i) information on a group including the at least one storage device transmitting the outlier notification, (ii) information on storage devices included in the group, (iii) information on command included in the sliding window at a time point at which the outlier notification is received, (iv) command input/output history information of the at least one storage device transmitting the outlier notification, or (v) telemetry data of the at least one storage device transmitting the outlier notification.

13. A storage device comprising:
a memory device comprising a trap area in which a trap file transferred from a host is stored; and
a memory controller configured to set a logical block address (LBA) range corresponding to the trap area as a write protection area, and generate an outlier notification when an access to the write protection area is detected.

14. The storage device of claim 13, wherein:
the memory controller is configured to transmit the outlier notification to a system controller external to the storage device via an asynchronous event.

15. The storage device of claim 14, wherein:
the memory controller, when an operating speed change request is received from the system controller in response to the transmission of the outlier notification while controlling the storage device to operate in a first power state among a plurality of power states, is configured to control the storage device to operate in a second power state having a lower operating speed than the first power state in response to the operation speed change request.

16. The storage device of claim 14, wherein:
the memory controller is configured to transmit at least one of command input/output history information or telemetry data of the storage device to the system controller in response to an information request related to the outlier notification when the information request is received from the system controller in response to the transmission of the outlier notification.

17. A method of operating a storage system comprising a plurality of storage devices, the method comprising:
storing a trap file in a trap area of each of the plurality of storage devices;
controlling operations of the plurality of storage devices based on a plurality of commands received from a host;
reducing an operating speed of a first storage device among the plurality of storage devices when an access to a trap area of the first storage device is detected; and
performing a malware detection operation based on a predetermined number of commands, among the plurality of commands, corresponding to a time point at which the access to the trap area was detected.

18. The method of claim 17, wherein:
each of the plurality of storage devices operates in one of a plurality of power states having different operating speeds; and
the reducing of the operating speed comprises modifying a power state of the first storage device.

19. The method of claim 17, comprising:
storing information on the plurality of commands based on a sliding window having a predetermined size,
wherein:
the performing of the malware detection operation comprises:
extracting a plurality of features from information on commands included in the sliding window at the time point at which an access to the trap area was detected; and
applying the extracted features to a malware detection algorithm based on machine learning to perform the malware detection operation.

20. The method of claim 19, comprising:
providing information related to the access to the trap area to the host,
wherein:
the information related to the access to the trap area comprises at least one of information on a group including the first storage device, information on storage devices included in the group, information on commands included in the sliding window at the time point at which the access to the trap area was detected, command input/output history information of the first storage device, or telemetry data of the first storage device.
